(19) United States
(12) Patent Application Publication
(10) Pub. No.: US 2005/0067913 A1
(43) Pub. Date: Mar. 31, 2005

(54) Reduction of cogging torque in electric motors

(75) Inventors: Sergei Kolomeitsev, Rochester, MI (US); John R. Suriano, Auburn Hills, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC., AUBURN HILLS, MI (US)

(21) Appl. No.: 10/675,465

(22) Filed: Sep. 30, 2003

(51) Int. Cl. H02K 1/00

(52) U.S. Cl. 310/216

(57) ABSTRACT

An electric motor having reduced cogging torque. Motors have stator teeth separated by a slot, or space, which is filled with air and/or copper. The magnetic field present in the space is reduced, compared to that present in the iron cores. Thus, when the rotor rotates, it sees a changing magnetic field as it passes a tooth face, then a slot, and then a neighboring tooth face. This change can produce a force or cogging torque in the motor. The invention changes the geometry of the tooth face and slot to reduce variation of reluctance and increase overall flux of the stator.

### BACKGROUND OF THE INVENTION

In many types of electric motor, the rotor does not spin freely when electric power is absent. When one manually rotates such a rotor, one feels a succession of detents, as it were. Each detent represents a preferred position at which the rotor seeks to rest.

Perhaps the simplest illustration of this phenomenon is found in the permanent-magnet stepper motor, a simplified version of which is schematically illustrated in FIGS. 1-3. FIG. 1 illustrates four pairs of coils. A wire 6 connects coil-pair members 3A and 3B. The corresponding wires for the other pairs are not shown, to avoid clutter. Each coil is wound around a core 9, which is constructed of iron, or other high-permeability material.

When a current I passes through coil-pair 3A and 3B, a magnetic field B1 is generated. In one mode of operation, the coil-pairs are energized in sequence, as shown in FIG. 2. That is, field B1 is first created. Then field B1 terminates, and field B2 is generated. Then field B2 terminates, and field B3 is generated, and so on. A rotating magnetic field is created.

FIG. 3 illustrates schematically the rotor of the motor, in the form of a single bar magnet 12. The bar magnet 12 tends to align itself with the rotating magnetic field, not shown in FIG. 3, and assumes the successive positions 13, 14, 15, and 15 indicated in FIG. 4.

The net effect is that the rotating magnetic field of FIG. 2 induces rotation in the bar magnet 12 of FIG. 4.

However, when no current passes through any coil, the bar magnet 12 does not assume one of an infinite number of possible rest positions. Instead, the magnet 12 preferentially aligns itself with a pair of coils, as in FIG. 3. If one manually displaces the bar magnet 12 slightly from this rest position, and then releases the bar magnet 12, the bar magnet 12 will return to its previous rest position.

A simple explanation is that the bar magnet is attracted to the iron in the cores, and pulls itself toward the nearest iron available. The Detailed Description of the Invention, below, offers a more complex explanation, applicable to more general cases. This pull of the bar magnet into a preferred rest position is variously given the term cogging torque, detent torque, salient pole torque, reluctance torque, and possibly other terms.

This torque also is present when the motor is operating. This torque is superimposed on the torque induced by the rotating magnetic field. Thus, each time the bar magnet 12 passes a pair of iron cores, such as pair 3A and 3B, a small cogging torque accelerates the bar magnet 12 slightly as the bar magnet 12 approaches the pair, and later another small cogging torque decelerates the bar magnet 12 slightly as the bar magnet 12 departs from that same pair.

This repeated acceleration and deceleration creates vibration in the motor, which is not desirable in some situations. This vibration is particularly undesirable in electric power assistance steering (EPAS). One reason is that, since the motor drives an EPAS, and since the vibration actually takes the form of periodic accelerations and decelerations of the motor, the vibration can cause small pressure pulses in the EPAS. These pulses may be detected in the driver's hands on the steering wheel, and may cause annoyance. Also, depending on the particular hydraulic linkage existing between the EPAS and the forward wheels, the periodic pressure pulses can cause slight periodic changes direction of the vehicle, causing tire wear and wheel vibration.

### OBJECTS OF THE INVENTION

An object of the invention is to reduce cogging torque in electric motors.

### SUMMARY OF THE INVENTION

In one form of the invention, radial slot openings between adjacent stator teeth in an electric motor are changed to a non-radial configuration, to increase magnetic flux exiting the slots.

These and other objects and advantages of the invention will be apparent from the following description, the accompanying drawings and the appended claims.

### BRIEF DESCRIPTION OF THE DRAWINGS

FIGS. 1-4 are highly simplified representations of a prior-art permanent magnet motor, such as a stepper motor;

FIG. 5 illustrates one form of the invention;

FIG. 6 illustrates how a magnetic flux is computed;

FIG. 7 illustrates a discontinuous ring 21F, and is used to show how gap G forces the magnetic flux to be smaller, compared with FIG. 6;

FIG. 8 illustrates an electrical model used to compute the magnetic flux of FIG. 7;

FIGS. 9 and 10 illustrate an electromagnet in two configurations;

FIG. 11 is a schematic representation of stator teeth 70 and a rotor pole 78 in a prior-art electric motor;

FIG. 12 is a representation of magnetic flux lines in the apparatus of FIG. 11;

FIG. 13 illustrates one form of the invention;

FIG. 14 is a representation of magnetic flux lines in the apparatus of FIG. 13;

FIGS. 15-19 illustrate how magnetic flux density decreases as the two iron bodies 100 and 105 are rotated about point 125;

FIG. 20 illustrates the magnetic flux of FIG. 19, but placed in the slot opening 74 in FIG. 11;

FIG. 21 illustrates the slot opening of the invention of FIG. 13;

FIG. 22 illustrates the magnetic flux of the type shown in FIGS. 15-18, placed in the slot of FIG. 21;

FIGS. 23-25 illustrate one conception of how one form of the invention can be constructed; and

FIG. 26 illustrates reference lines and directions for one form of the invention.

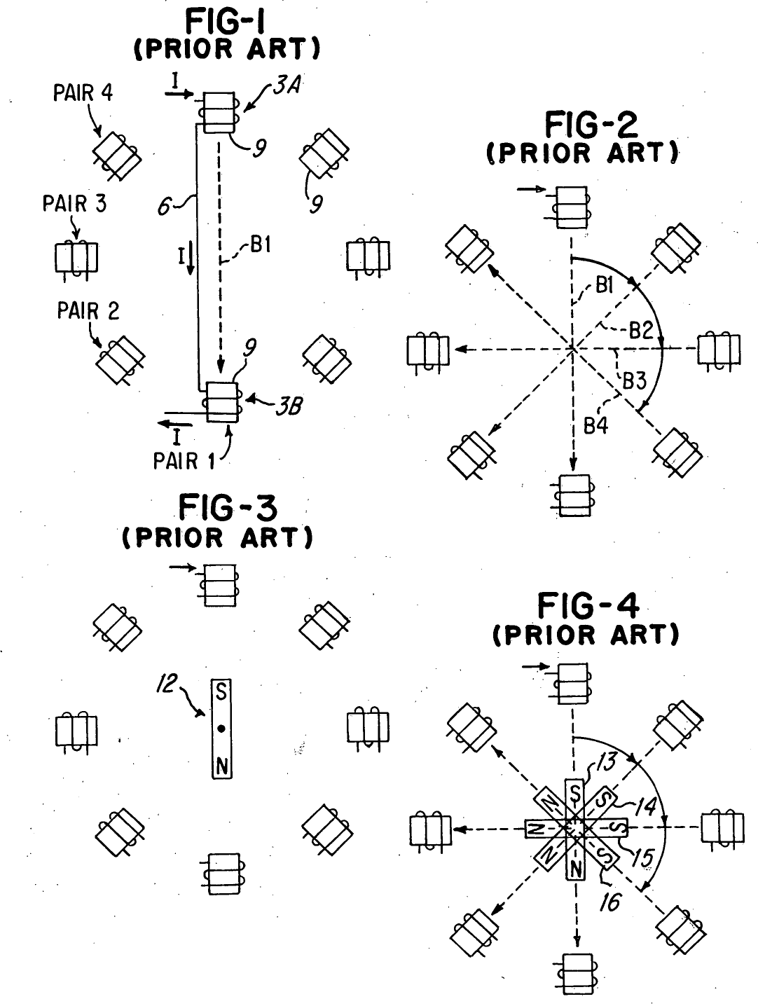

### DETAILED DESCRIPTION OF THE INVENTION

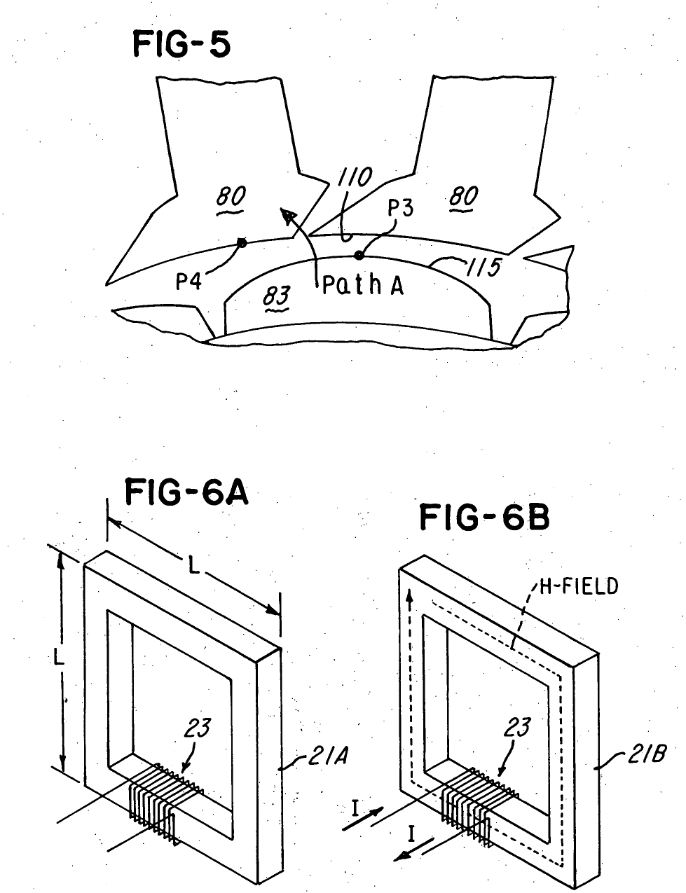

FIG. 5 illustrates one form of the invention. An analysis will be given which explains, from one perspective, why this form of the invention reduces cogging torque. At the basis of this analysis are the following three concepts.

One concept is that when a magnetic field is present in a system, forces arise which tend to move the components of the system into a configuration in which magnetic reluctance is reduced, and minimal if possible. For example, when an ordinary horseshoe magnet attracts an iron nail to its legs, the magnetic reluctance of the system is reduced when the nail is in contact with the legs of the magnet, compared to the reluctance when the nail is one foot away.

Another concept is that when a magnetic field is created by an electric current in a system, forces are created which tend to move the components of the system into a configuration which increases, or maximizes, inductance of the system.

A third concept is that in applying either of the above two concepts, if a change in configuration causes a relatively large change in inductance or reluctance, then relatively large forces are involved. Conversely, if a change in configuration causes a relatively small change in inductance or reluctance, then relatively small forces are involved. Thus, if two mechanically identical systems A and B are compared, and if movement in system A causes a small change in reluctance or inductance, compared with system B, then the forces in system A will be less than those in system B.

These concepts will explain how reluctance and inductance of a generalized system change as internal parts of the system move, thereby creating forces. This analysis will then be applied to the device of FIG. 5 to explain how movement of internal parts causes the forces responsible for cogging torque.

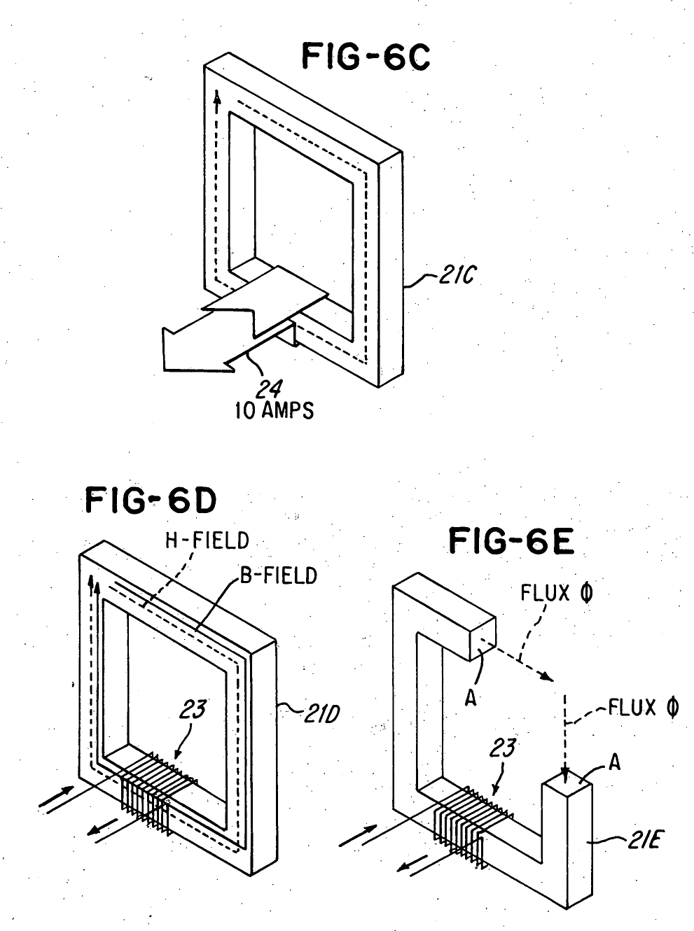

FIG. 6 shows five copies 21A-21E of a square iron ring having sides of length L. A coil 23 is wound around ring 21A, and contains 10 turns.

When a current I is generated in the coil 23, a magnetic field H is generated, indicated in ring 21B. Field H is called the magnetic field intensity, and can be calculated using the following equation.
NI=4LH

N is the number of turns, 10; I is the current; and H is the magnetic field intensity.

In FIG. 5, L is indicated as the outer dimension of the square ring 21A. For simplicity, length 4L is taken as the average path length traversed by a path running through the center of each leg. This path, of course, is slightly less than 4L.

The expression NI represents the current I multiplied by the number of turns in the coil 23. It should be observed that the current I passing ten times around ring 21B is, for present purposes, identical in effect to a sheet current ten times as large, passing around ring 21C once, as indicated by the single arrow 24 wrapped around ring 21C.

In this example, if I equals one amp, then H=10/4L. If L is one meter, then H=2.5. The units of H are amperes, or ampere-turns, per meter. Thus, H equals 2.5 ampere-turns per meter. H is also called a magneto-motive force, MMF.

The H-field is accompanied by another field, the B-field indicated in ring 21D. The B-field represents magnetic field density, as opposed to magnetic field intensity, represented by H.

The B-field in ring 21D in FIG. 5 can be computed using the following equation:
B=μᵣμ₀H
wherein
μᵣ is the relative permeability of the iron of ring 21D,
μ₀ is the permeability of vacuum, and
H is the magnetic field intensity, computed above.

The constant μᵣ for iron lies in the range of 4,000, and for modern high-permeability materials can be as high as one million, or more. For air, the relative permeability μᵣ is very close to unity.

A significant fact, which will be applied in greater detail later, can be observed here. If ring 21D were constructed of air, the magnetic field density, B, would have a certain value, determined from the equation B=μ₀H, since, as just stated, μᵣ for air is unity for practical purposes.

However, if ring 21D were constructed of iron, or other high permeability material, the magnetic field density B can be 4,000 to one million times larger, because the following equation applies, and μᵣ is far greater than unity.
B=μᵣμ₀H

Restated, placing iron, or other high-permeability material, into a region occupied by an H-field will increase the magnetic field density, namely, the B-field, and will increase the B-field by a factor of 100 to one 5000.

Thus, if a system can rearrange itself so that more iron, or other high-permeability material, becomes positioned in a path occupied by an H-field, then a larger B-field will be created. Consequently, according to the two concepts described above, forces will be generated which promote this rearrangement, since the rearrangement (1) decreases reluctance, (2) increases inductance, or both.

Stated more simply, if a system can rearrange itself to place high permeability material into a path occupied by an H-field, forces will arise which promote that rearrangement.

Once B is computed, which gives the field density in terms of Webers per square meter, one computes the total magnetic flux.

The computation, in mathematical form, is analogous to computing total force applied by a given pressure. For example, a pressure of 100 pounds per square inch may be present. If that pressure is applied to 9 square inches, then the total force applied is 100×9, or 900 pounds.

Similarly, a given B-field may be X Webers per square meter. If that B-field is applied to 9 square meters, then the total flux (termed flux) is 9× Webers. In both cases, a parameter per unit area is present: pounds per square inch in the case of pressure, and Webers per square meter, in the case of the magnetic field. One finds the total value of the parameter (force or flux) by multiplying by the area over which the parameter is applied.

In FIG. 5, ring 21E is shown cut away. The area in question is labeled A. If B, shown in ring 21D, is multiplied by A, the result is the total flux φ, in units of Webers (assuming B to be uniform across area A).

A specific example will be given. This example will be contrasted with a slightly different example, given later for a discontinuous ring. For the first example, the following values are assumed:
μᵣ=4,000
μ₀=4×PI×10⁻⁷ Henries per meter
A=0.01 square meter
Variable H was computed above, and is 2.5 ampere-turns per meter. B thus equals (4,000)(4×PI×10⁻⁷)(2.5), or 0.0126 Webers/meter² Flux, φ, equals BA, or (0.0126)(0.01), or 0.000126 Weber.
Inductance equals φ/I, the ratio of the flux to the current producing it. Since the current is one amp, the inductance is 0.000126 Henry.

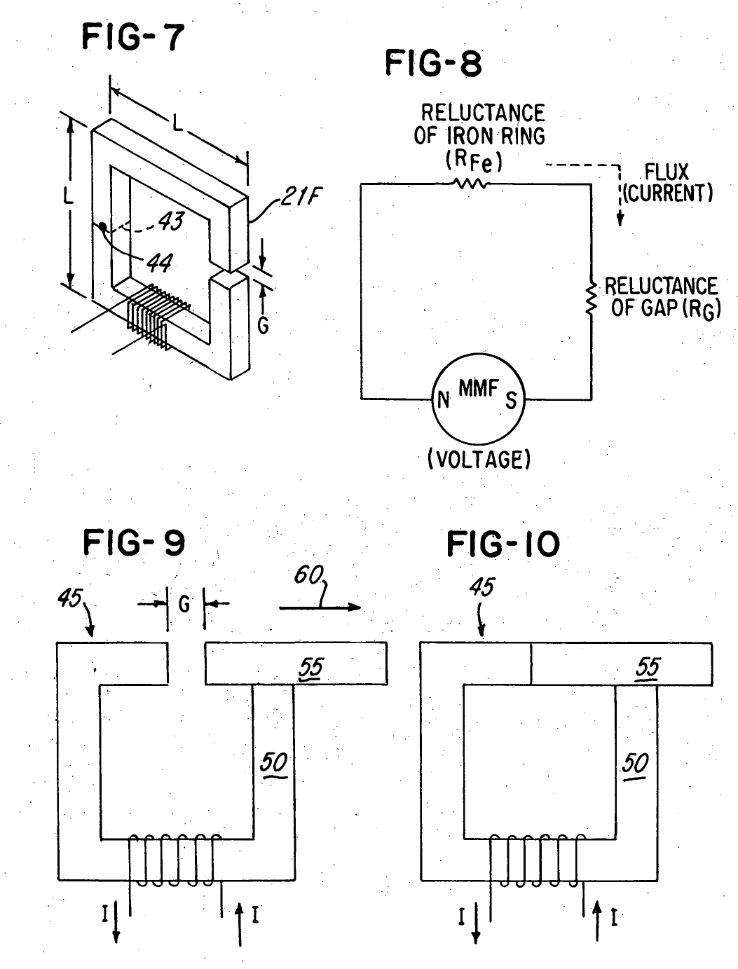

It will now be shown how this value of inductance decreases when an air gap G is inserted into ring 21F, as in FIG. 7. However, the computation will be done differently, in order to explain the concept of reluctance.

The flux φ in the ring 21F is analogous to electric current, and the system can be modeled as shown in FIG. 8. The parenthetical symbols refer to the electrical model. In the electrical model, where two resistors R_{G} and R_{L} are connected in series, the same current passes through both resistors.

Similarly, in the magnetic case, (1) the iron of the ring and (2) the air in the gap G are connected in series, and the same flux φ passes through both.

Mathematically, the two cases are identical. In the electrical case, Ohm's Law is obeyed:
V=I(R_{G}+R_{Fe})
wherein
V is the voltage,
I is the current, and
R_{G} and R_{Fe} are resistors.

In the magnetic case, an equation of the same form is used:
MMF=φ(REL_{Fe}+REL_{G})
wherein
MMF is the Magneto Motive Force,
φ is the flux, and
REL_{Fe} and REL_{G} are the magnetic reluctances of the iron and air gap G.

For the magnetic case, each reluctance REL is computed using the following equation:
REL=L/Aμᵣμ₀
wherein
L is the length of the material (and not to be confused with inductance L),
A is the cross-sectional area, and
μᵣ and μ₀ are defined above.

Assume that the length of gap G in FIG. 6 is 0.01 meter, or one centimeter. The reluctance of the gap G is thus
0.01/(0.01)(1)(4×PI×10⁻⁷) or 796,178.

Reluctance has the units of inverse-Henry, H⁻¹.

The reluctance of the discontinuous iron ring will be computed. Since the length of G is very small compared to 4L (ie, one centimeter compared to 400 centimeters, or 0.25 percent), the length of the iron will be treated as 4L for simplicity. The reluctance of the iron is thus
4/(0.01)(4,000)(4×PI×10⁻⁷) or 79,617H⁻¹.
The reluctance of the iron is about ten percent of that of the air gap.

The total reluctance in FIG. 7 is thus the sum, or 875,795H⁻¹. If the MMF is 10 ampere-turns, as above, then the flux is determined by the magnetic equivalent of Ohm's law:
fluxΦ=10 amp-turn/(reluctance)=10/875,795=1.14×10⁻⁵ Webers

The inductance of the structure in FIG. 7 is, as above, φ/I. Substituting numerical values gives an inductance of 1.14×10⁻⁵ Henries. In contrast, the inductance of the solid ring of FIG. 6 was computed as 0.000126 Henry, roughly ten times larger.

Therefore, the Inventor points out that the inductance of the structure of FIG. 7 is significantly less than that of FIG. 6, even though the amount of iron in the magnetic circuit is practically the same in both cases.

The air gap G in FIG. 7 is responsible for reducing the inductance. If one returns to the electrical model, it is clear that, if resistance R_{G} in FIG. 8 is extremely large, compared with R_{Fe}, the former dominates the total series resistance. The current is drastically reduced, compared to the case where R_{G} is absent, or small.

Similarly, the reluctance of the air gap G is very large, because of the low permeability of the air, namely, μ₀. The high reluctance of the air gap G dominates the total series reluctance of the air-plus-iron in FIGS. 6 and 7. The high reluctance of the air gap G drastically reduces the flux φ. The reduction in flux reduces the inductance.

These facts can be used to explain how a force can be created in a magnetic circuit, according to the first two concepts outlined at the beginning of this discussion.

As a simple example, if the discontinuous ring 21F in FIG. 7 were split along dashed line 43, so that the two parts could pivot about point 44, application of a current would cause the gap G to decrease. One reason, according to the concepts outlined at the beginning of this discussion, is that reducing the gap G will decrease the reluctance of the gap G, REL_{G}. The system prefers to assume a configuration of reduced reluctance.

Another reason is that the reduced reluctance increases the flux φ in the ring, for a given current. That increases inductance. The system prefers to assume a configuration of increased inductance.

Another example will be given with reference to FIG. 9, which illustrates an electromagnet 45, having a stationary iron section 50 and a freely movable iron section 55, movable in the direction of arrows 60. When a current I is applied, the movable iron section moves into the position shown in FIG. 10, closing the gap G of FIG. 9.

This movement occurs because the configuration of FIG. 9 has a relatively low inductance, similar to that of FIG. 7. From another point of view, the reluctance seen by the H-field (not shown) in traversing the path around the iron-plus-air-gap-G in FIG. 9 is relatively high, because of the presence of the air gap G, in the same manner of FIG. 7.

In contrast, the system of FIG. 10 has a relatively low reluctance, because of the absence of the air gap, analogous to FIG. 6. The low reluctance of FIG. 10 creates a higher flux φ, not shown, with a corresponding higher inductance, because inductance is defined as φ/I.

Forces are created which rearrange the system into the configuration of FIG. 10, compared with FIG. 9, based on the first two concepts described at the beginning of this Detailed Description. The system seeks a configuration of high inductance, low reluctance, or both.

This discussion will now apply the preceding principles to the present invention.

FIG. 11 illustrates a partial cross-section of a motor in the prior art. Iron stator teeth, 70, carrying coils 73, are separated by slot opening 74. In some embodiments, the slots 74 may contain copper current-carrying bars (not shown). A pole 78 of the rotor is shown.

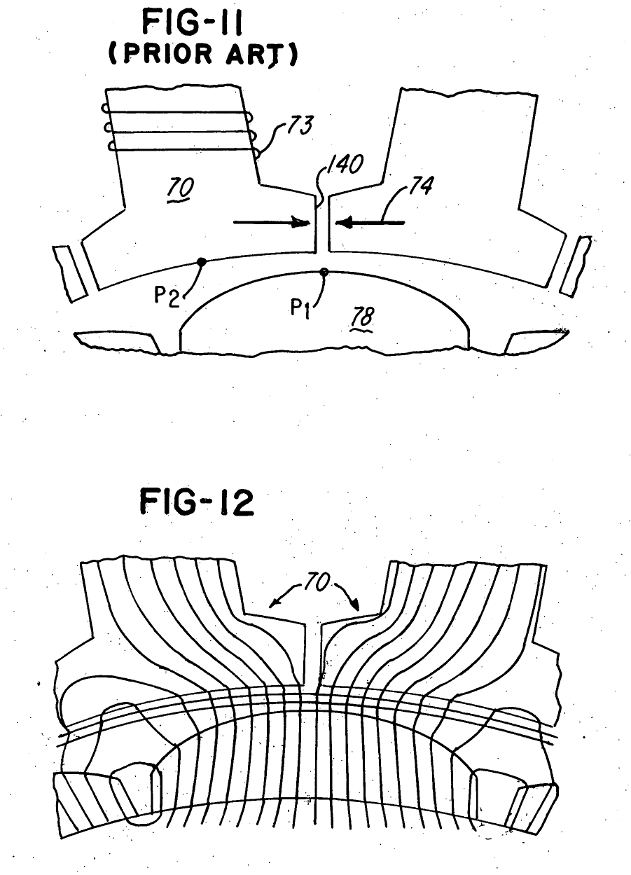

FIG. 12 shows flux lines superimposed on the structure of FIG. 11. The flux lines were drawn by the Inventor using flux mapping techniques.

FIG. 11 shows the rotor pole 78 in a particular position, wherein the pole 78 is positioned directly across from slot opening 74, or in a mid-slot position, between two teeth 70. If the rotor pole 78 is rotated so that point P1 becomes adjacent point P2, then pole 78 is no longer directly across from slot opening 74. In this position, a larger flux (not shown) enters the tooth 70 from the pole 78, compared with the situation of FIGS. 11 and 12.

One explanation for this larger flux is that more iron is present in the path which the flux follows from pole 78 to the tooth 70, because slot opening74 is at the fringes of that flux when point P1 is aligned with P2.

With the larger flux present, a lower reluctance, a higher inductance, or both, are found, based on the principles described above.

Thus, one or more forces exist tending to move the system from the configuration of FIGS. 11 and 12 to the configuration where point P1 is adjacent P2. These types of forces are responsible for the cogging torque.

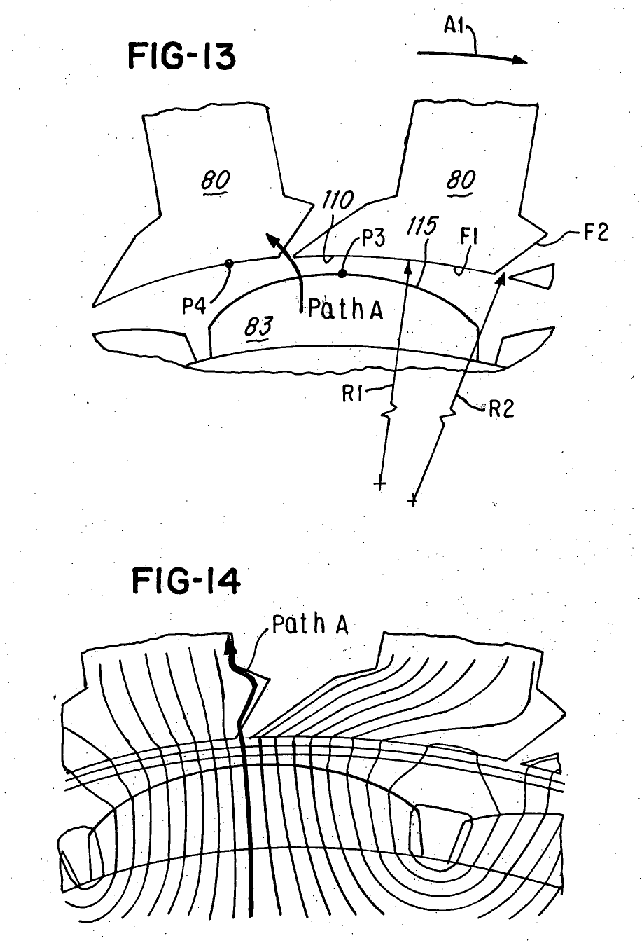

FIG. 13 illustrates one form of the invention, and FIG. 14 shows superimposed flux lines. A comparison of FIG. 14 with FIG. 12 shows that an extra flux line exists in FIG. 14, and is labeled Path A. Thus, the reluctance of the system of FIGS. 13 and 14, in the position shown, is lower than that of FIGS. 11 and 12, in the position shown.

Forces still exist in FIGS. 13 and 14 tending to rotate the pole 83 so that P3 is adjacent P4. However, these forces are reduced, compared with the corresponding forces in FIGS. 11 and 12. One reason is that the change in inductance (from the situation of FIG. 13 to that in which P3 is aligned with P4 in the same Fig.) which accompanies this rotation of pole 83 is less under the invention, compared with the corresponding change in reluctance (from the situation of FIG. 11 to that in which P1 is aligned with P2) in FIGS. 11 and 12.

Stated another way, when P3 becomes aligned with P4 in FIG. 13, a change in reluctance occurs, compared with the configuration actually shown in that same Fig. However, that change is less than the corresponding change in FIG. 11. One reason is that the flux entering tooth 80 in FIG. 14 is larger, compared with the corresponding flux in FIG. 12, because of the added flux indicated by Path A.

Consequently, when the rotor pole 83 rotates so that points P3 and P4 become aligned in FIG. 13, the change in flux is not so great as the corresponding change in FIG. 11. Thus, the change in reluctance is not so great either. A simple numerical example will illustrate.

Assume the values shown in Table 1:

TABLE 1

| | | Flux Value |
|---|---|---|
| Case | Rotor Position | (arbitrary units) |
| 1 | | F |
| 2 | | F + A |
| 3 | P1 and P2 aligned (FIG. 11) | X |
| 4 | P3 and P4 aligned (FIG. 13) | X |

The term “Flux Value” refers to the flux entering the rotor pole 78 or 83. “A” represents the extra flux in Path A in FIG. 13.

It is assumed that the position where P1 and P2 are aligned (case 3) experiences the same flux as where P3 and P4 (case 4) are aligned. This is considered reasonable, because the invention provides no significant structural change at those aligned points.

The change in flux in the prior-art system is found by subtracting Case 3 from Case 1, and equals F−X. Under the invention, the corresponding change is Case 4-Case 2, and equals F−X−A.

Under the invention, the change in flux is less by quantity A. Consequently, the cogging torque is correspondingly smaller under the invention, based on the third concept discussed at the beginning of the Detailed Description of the Invention.

This reduction can be explained from another perspective. The pole 78 in FIG. 11, and the corresponding pole 83 in FIG. 13, create a given amount of flux. The quantity of flux can be computed from the equation
Flux=MMF/Reluctance

The magnet pole strength (MMF) in FIGS. 13 and 14 are the same, compared with the corresponding magnet pole strength in FIGS. 11 and 12. As explained above, MMF in the equation immediately above is equal to the current, multiplied by some constants. For permanent magnet poles this may be considered to be an equivalent current. However, in FIG. 14, flux has increased, as indicated by the extra flux line following Path A.

Thus, according to the equation immediately above, reluctance in FIG. 13 has decreased, compared with FIG. 11. Thus, a given change in reluctance occurs when the rotor pole 83 in FIG. 13 moves into the position of that Fig., from the position where points P3 and P4 were aligned. Another change in reluctance occurs when the rotor pole 78 in FIG. 11 moves into the position of that Fig., from the position where points P1 and P2 were aligned.

The former change in reluctance is less than the latter. Thus, by the third concept discussed at the beginning of the Detailed Description of the Invention, the forces involved in the former are less than in the latter. The invention reduces cogging torque.

The invention can be explained from yet another perspective. FIG. 15 illustrates two blocks of iron 100 and 105. Block 105 corresponds to the inner surface 110 of a stator tooth in FIG. 13. Block 100 corresponds to the outer surface 115 of the rotor pole 83. The solid lines in FIG. 15 represent the B-field. The dashed lines represent equipotential surfaces of U, magnetic potential. Dashed box 120 represents a flux tube.

Flux tubes are described, for example, in the text Electromagnetics, by John D. Kraus (McGraw-Hill, 1992, ISBN 0-07-035621-1). This text is hereby incorporated by reference.

If block 105 is progressively rotated about point 125, as in FIGS. 16-18, the width W of the flux tubes near the separating ends 130 and 135 increases.

One reason is that, under the rules for drawing flux tubes as outlined in the text just identified, the tubes are constructed of stacks of approximately square blocks, termed curvilinear squares. However, the number of squares in each stack remains approximately constant. Thus, if the length of a stack increases, as occurs in tube 8 during the change from FIG. 15 to FIG. 16, the width of the stack must also increase.

Thus, the sequence of FIGS. 15-18 shows that the flux density in the tubes is decreasing, because flux density is inversely proportional to the width W of the tube.

When block 105 reaches the position shown in FIG. 19, it corresponds roughly to a side face 140 of a prior-art slot opening 75 in FIG. 11. The width W in FIG. 19 of the flux tube 2 is much greater, compared with that in FIGS. 16-18. The flux density is significantly reduced in FIG. 19.

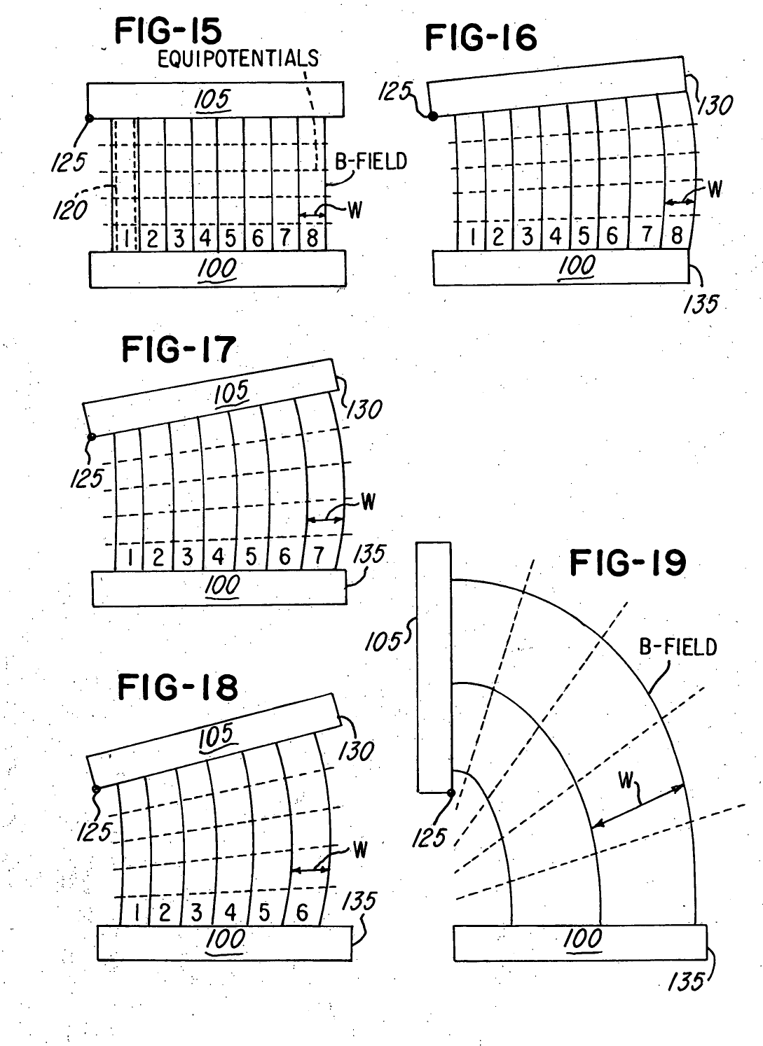

FIG. 19 is not drawn to scale, but is used to show the general principle that the flux density in a flux tube such as tube 2 is greatly reduced, compared with a tube in the corresponding position on block 100 in, say, FIG. 17.

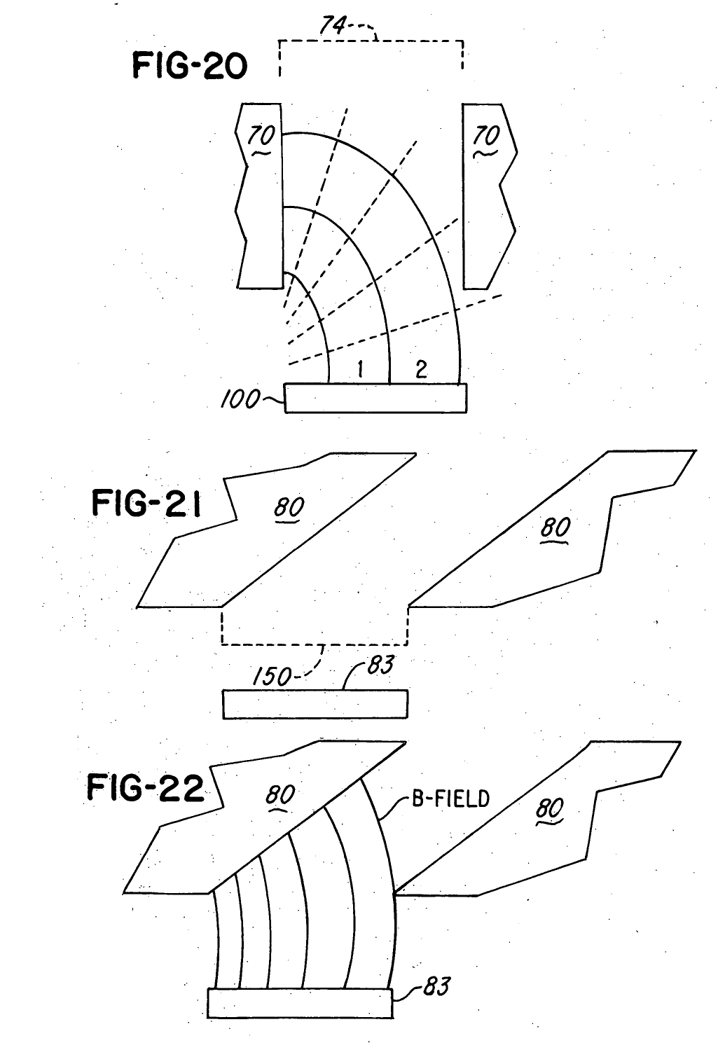

FIG. 20 is a representation of the flux tubes of FIG. 19, but positioned within a slot opening 74 of FIG. 11. Block 100 corresponds to the rotor pole 78 of FIG. 11. In contrast, FIG. 21 shows a slot opening 150 according to the invention, adjacent the rotor pole 83 (corresponding to block 100 in FIG. 18. FIG. 22 shows flux tubes of the type in FIG. 16, 17, or 18 superimposed on the slot opening of FIG. 21.

Plainly, in FIG. 22, a larger number of flux tubes reach block/rotor-pole 83, compared with FIG. 20. The larger flux means that reluctance of the system of FIG. 22 is reduced, compared with that of FIG. 20.

In FIG. 22, the flux lines reaching the rotor pole 83 originate from a high-permeability body, or bulge, 80 which is radially outward of the pole 83. One definition of “high permeability” is that the relative permeability is 3,000 or greater. Another definition is that a “high permeability” material is suitable for use as transformer iron.

In contrast, no such radially outward body of high permeability material exists in FIG. 20. Pure air is radially outward in FIG. 20.

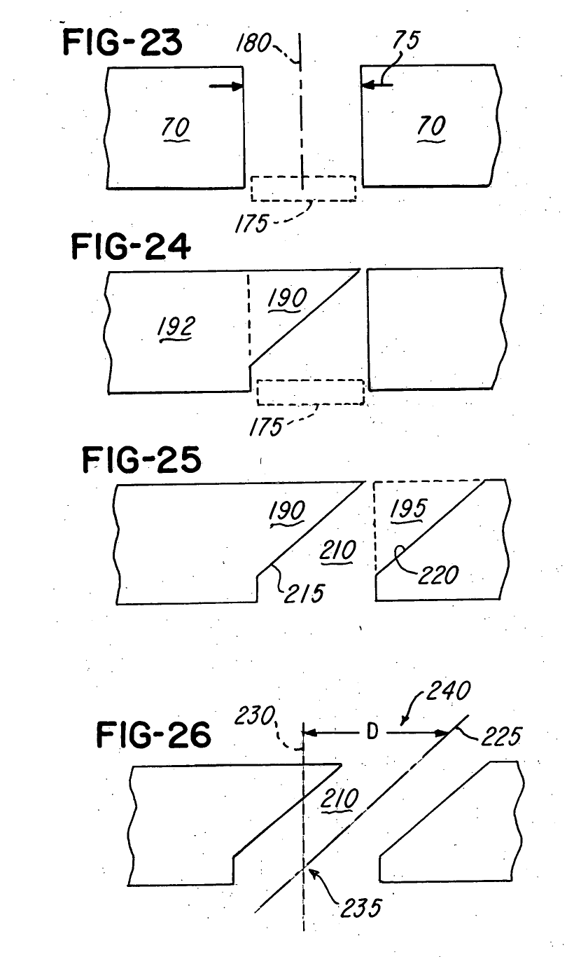

The invention can be characterized in yet another manner. FIG. 23 slot opening 75 illustrates the slot opening 74 of FIG. 11. Slot opening 75 runs along a radial axis 180, and has a radially inner mouth, exit, or opening, indicated by dashed box 175.

Under one form of the invention, a high-permeability body 190 is positioned within the slot opening 75, as in FIG. 24. Body 190 is magnetically continuous with the adjacent material 192 of the stator phase. In addition, material 195 in FIG. 25 may be removed, forming a slot opening 210 having generally parallel walls 215 and 220.

In one form of the invention, body 190 is also physically continuous with the adjacent material 192 of the stator tooth. That is, if two high-permeability bodies are physically adjacent, but separated by a very thin low-permeability sheet, it could be stated that they are nevertheless magnetically continuous. For example, if the air gap G of FIG. 7 were extremely thin, so that it did not reduce the flux to any significant extent, it could be said that the ring 21F is magnetically continuous.

In contrast, ring 21D, for example, is not only magnetically continuous, but physically continuous. No foreign material splits the ring, as in ring 21F.

Several definitions of magnetically continuous are the following. Preferably, the ring 21F in FIG. 7 is considered magnetically continuous if air gap G does not reduce the flux by more than 5 percent, compared with FIG. 6, given comparable dimensions and currents. In other embodiments, the percentage of five just stated can be increased to any values between 6 and 20.

### Additional Considerations

1. One view of the invention is that, when the rotor pole is aligned as in FIG. 13, that is, when the center of the rotor pole is aligned with the inner opening of the slot opening, the rotor is located at a mid-slot position. It is midway between adjacent stator teeth.

2. A central axis 225 can be defined in FIG. 26, which is located mid-way in the slot opening 210. If the slot opening is tapered, the axis 225 can follow the midline between the slot opening walls 215 and 220 in FIG. 25.

The central axis 225 is non-radial, as is the slot opening itself. Further, a radially inner part 235 may cross a radius 230. A radially outer part 240 may be spaced from the radius 230 by distance D.

3. FIG. 11 indicated that coil 73 surrounds a stator tooth 70. In one form of the invention the stator coil may reside in a slot opening of FIG. 13 instead of, or in addition to, a corresponding coil in FIG. 13.

4. From one perspective, the invention provides a stator core 80 in FIG. 13, which has a compound inner face which includes two surfaces F1 and F2. Surface F1 faces radially inward, and follows a constant radius R1. Surface, or facet, F2, is located radially outward of the exit 175 in FIG. 24, and follows an increasing radius R2 in FIG. 13.

From another perspective, as one moves circumferentially, in the direction of arrow A1 in FIG. 13, one encounters an inner face F1 of constant radius R1, and then a facet F2 of progressively increasing radius R2. Facet F2 borders the slot opening 210 in FIGS. 25 and 26, which separates the cores 80 in FIG. 13.

Numerous substitutions and modifications can be undertaken without departing from the true spirit and scope of the invention. What is desired to be secured by Letters Patent is the invention as defined in the following claims.

1. An electric motor, comprising:
a) a pair of stator teeth, having a stator slot therebetween, the stator slot having a radial slot opening; and
b) means for increasing magnetic flux passing through the slot opening.

2. The motor according to claim 1 wherein the means comprises a body located radially outward of the slot opening.

3. The motor according to claim 2 wherein the means is magnetically and physically continuous with one of the stator teeth.

4. The motor according to claim 1 wherein the means reduces cogging torque of the motor.

5. An electric motor, comprising:
a) a pair of stator teeth, having a stator slot therebetween, the stator slot having a radial slot opening; and
b) a body located radially outward of the slot opening, which increases magnetic flux passing through the slot opening.

6. The motor according to claim 5 wherein the body is magnetically continuous with one of the teeth.

7. The motor according to claim 5 wherein the body is physically continuous with one of the teeth.

8. The motor according to claim 5 wherein the body is both physically and magnetically continuous with one of the teeth.

9. The motor according to claim 5, wherein the body reduces cogging torque of the motor.

10. In an electric motor having a rotor, the improvement comprising:
a) stator coils, and
b) stator core means for decreasing mid-slot reluctance of the rotor.

11. The improvement according to claim 10, wherein the stator core means comprises a slot having a central axis, and said central axis is non-radial.

12. The improvement according to claim 11, wherein said central axis has
i) a radially inner region which crosses a radial line of the rotor, and
ii) a radially outer region which is spaced circumferentially from said radial line.

13. In an electric motor having a rotor, the improvement comprising:
a) stator teeth, and
b) a non-radial slot opening separating neighboring stator teeth.

14. The improvement according to claim 13, wherein the non-radial slot opening decreases mid-phase reluctance of the rotor, compared with a radial slot opening.

15. The improvement according to claim 13, wherein the non-radial slot opening decreases cogging torque, compared with a radial slot opening.

16. The improvement according to claim 13, wherein the non-radial slot opening comprises a central axis, and said central axis has
i) a radially inner region which crosses a radial line of the rotor, and
ii) a radially outer region which is spaced circumferentially from said radial line.

17. An electric motor, comprising:
a) a rotor;
b) an array of stator teeth surrounding the rotor, each stator tooth separated from its neighbor by a non-radial slot opening.

18. An electric motor having a rotor, comprising:
a) a circular array of stator teeth, each stator tooth separated from its neighbor by a slot opening;
b) a coil associated with stator teeth, for carrying an electric current which generates a magnetic flux which enters the rotor; and
c) means for increasing magnetic flux exiting the slot opening and entering the rotor.

19. The motor according to claim 18, wherein the slot openings are non-radial.

20. The motor according to claim 18, wherein the magnetic flux exiting the slot opening is increased compared with flux in an otherwise identical motor having radial slot openings.

21. An electric motor having a rotor, comprising:
a) a stator comprising a circular array of stator teeth, each stator tooth separated from its neighbor by a slot opening;
b) coil associated with each stator tooth for carrying an electric current which generates a magnetic flux which enters the rotor; and
c) means for reducing cogging torque compared with cogging torque present in a reference motor which is identical to said motor except for slot opening configuration.

22. The electric motor according to claim 21 wherein said motor comprises:
a) a pair of stator poles, having a stator slot therebetween, the stator slot having a radial slot opening; and
b) means for increasing magnetic flux passing through the slot opening.

23. The electric motor according to claim 21 wherein said means comprises a body located radially outward of the slot opening.

24. The electric motor according to claim 21 wherein said means is magnetically and physically continuous with one of said stator poles.

25. The electric motor according to claim 18 wherein said means reduces cogging torque of the motor.

26. An apparatus, comprising:
a) an electric motor having a rotor and a stator, wherein magnetic flux passing between the rotor and the stator changes as rotor position changes; and
b) means for reducing said changes.

27. An electric motor, comprising:
a) a first stator tooth having a first core;
b) a second stator tooth having a second core;
c) a space separating the first and second stator teeth and having a radially innermost slot opening;
d) a body which is magnetically continuous with the first stator tooth, and has a radially inner surface which is radially outside said innermost slot opening.

28. An electric motor, comprising:
a) a rotor;
b) a stator tooth having a radially inner face which includes
i) a first region of constant radius, and
ii) a circumferential boundary region to a slot opening that is not parallel to a radial line of said rotor.

29. The electric motor as recited in claim 28 wherein the circumferential boundary region does not lie in the same plane as the first region.

30. A method, comprising:
a) maintaining an electric motor having a radial array of stator teeth, each stator tooth having
i) a face which faces radially inward, and
ii) an associated gap which separates said face from a face of a neighboring stator core;
b) maintaining non-parallel sided boundaries between adjacent stator teeth.

31. An electric motor, comprising:
a) a pair of stator teeth, having a stator slot therebetween, the stator slot having a slot opening; and
b) means for increasing magnetic flux passing through the slot opening.

32. The motor according to claim 31 wherein the means comprises a body located radially outward of the slot opening.

33. The motor according to claim 32 wherein the means is magnetically and physically continuous with one of the stator teeth.

34. The motor according to claim 31 wherein the means reduces cogging torque of the motor.
